(19) United States
(12) Patent Application Publication
(10) Pub. No.: US 2025/0340133 A1
(43) Pub. Date: Nov. 6, 2025

(54) HIGH CURRENT FAULT ISOLATION FOR ELECTRIC VEHICLES

(71) Applicant: Rivian IP Holdings, LLC, Irvine, CA (US)

(72) Inventors: Kyle LOBO, Westchester, CA (US); Steven HANG, Long Beach, CA (US); Sanjeewa Keven SUGATAPALA, Long Beach, CA (US); Long Phi HUYNH, Brea, CA (US); Ajay KUMAR, Phoenix, AZ (US); Glenn Morris FEINBERG, Carlsbad, CA (US)

(21) Appl. No.: 19/088,760

(22) Filed: Mar. 24, 2025

Related U.S. Application Data
(60) Provisional application No. 63/642,590, filed on May 3, 2024.

(51) Int. Cl. B60L 50/64; H02H 7/26

(52) U.S. Cl. CPC B60L 50/64; H02H 7/268; B60L 2210/10

(57) ABSTRACT

A fault isolation system for electric vehicles may include an electronic control unit with an isolator switch connected to a direct current to direct current bus and a bidirectional switch connected to a low voltage battery bus. When a fault occurs on either bus, the corresponding switch opens while maintaining power through the alternate bus, enabling vehicle functions to continue operation.

### CROSS REFERENCE TO RELATED APPLICATION(S)

The present application claims the benefit of U.S. Provisional Application No. 63/642,590, entitled “HIGH CURRENT FAULT ISOLATION ON A DUAL BUS ARCHITECTURE WITH A LOW VOLTAGE BATTERY FOR ELECTRIC VEHICLES”, filed May 3, 2024, the entirety of which is incorporated herein for reference.

### INTRODUCTION

This application is directed to fault isolation, and more particularly, to batteries of a vehicle.

### SUMMARY

The disclosed subject matter relates to fault isolation systems for electric vehicles using electronic control units (ECUs). An ECU may include an isolator switch connected with a direct current to direct current (DCDC) bus and a bidirectional switch connected with a low voltage battery bus. Both switches may be connected with a common bus. In an example, when a fault occurs on the DCDC bus or the low voltage bus, the corresponding switch may open while allowing power transmission through the alternate bus to maintain vehicle functions. This architecture may provide redundant power paths or selective fault isolation while minimizing the need for high-dissipation diodes which may be used with some systems.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example block diagram of a system that includes a plurality of electronic control units (ECUs)

FIG. 2 illustrates an example block diagram of a fault isolation system.

FIG. 3 illustrates an example logic circuit diagram of the fault isolation system.

FIG. 4A illustrates an example method for fault isolation as disclosed herein.

FIG. 4B illustrates an example method for fault isolation as disclosed herein.

FIG. 5A illustrates an example overhead view of a vehicle with zonal power distribution as described herein.

FIG. 5B illustrates an example side view of a vehicle with zonal power distribution as described herein.

FIG. 5C illustrates an example block diagram of a system with zonal power distribution as described herein.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Electric vehicles feature safety critical systems, such as for steering, braking, or advanced driver assistance system (ADAS), that should retain function under loss of a power bus. Safety implementations that may be considered may include 1) shared power and diode Or'ing; 2) allow disconnection of the low voltage (LV) battery for reduced cycles; 3) allow a smart “diode” function for high current use without high dissipation diodes; or 4) allow fault isolation when LV battery may provide high current before direct current to direct current (DCDC) collapses. In some occurrences, the use of diodes may add cost or complexity, such as the need for thermal dissipation (e.g., active cooling).

Considered herein is a power architecture that may allow a system to power critical loads while isolating current excess (e.g., current excess of 250 A). The disclosed subject matter may include the use of bidirectional metal-oxide-semiconductor field-effect transistor (MOSFET) based switches with tuned switching thresholds on current or voltage. An isolator (Iso) switch may disconnect a DCDC bus, while a bidirectional (Bidi) switch may disconnect a low voltage battery bus. Testing has shown that the battery bus side may be more likely to trip by undervoltage, where a circuit causes battery current to sink from DCDC input. Testing has also shown that the DCDC bus may be more likely to trip by overcurrent, where a short circuit may cause battery current to sink from DCDC input. Wire lengths in the vehicle or other factors may be used to determine the thresholds for triggering the switches. In an example electoral component configuration, the DCDC set point may be approximately 13.25 to 13.75V (e.g., 13.5V), the LV battery setpoint may be 13V to 13.5V (e.g., 13.34V), the voltage trip rising may be approximately 10.5V, and the voltage trip falling may be approximately 9.5 V.

Using the switching techniques disclosed herein may allow for a simplified bus architecture isolating only the faulted bus and selectively powering the vehicle loads from the remaining healthy bus. The disclosed subject matter may allow for a relatively low bill of materials (BOM) cost solution while keeping redundant paths to critical subsystems. In addition, the disclosed subject matter may allow for a system that incorporates health monitoring (e.g., current or other indications of the health of a battery).

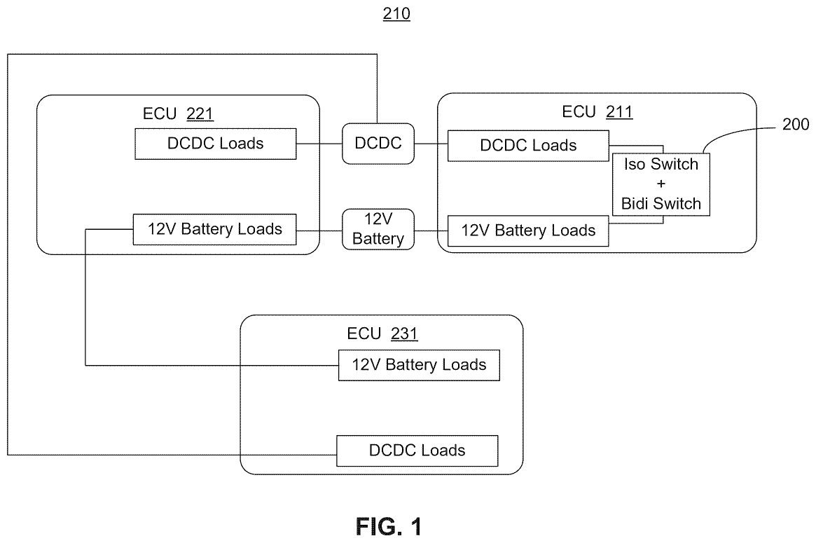

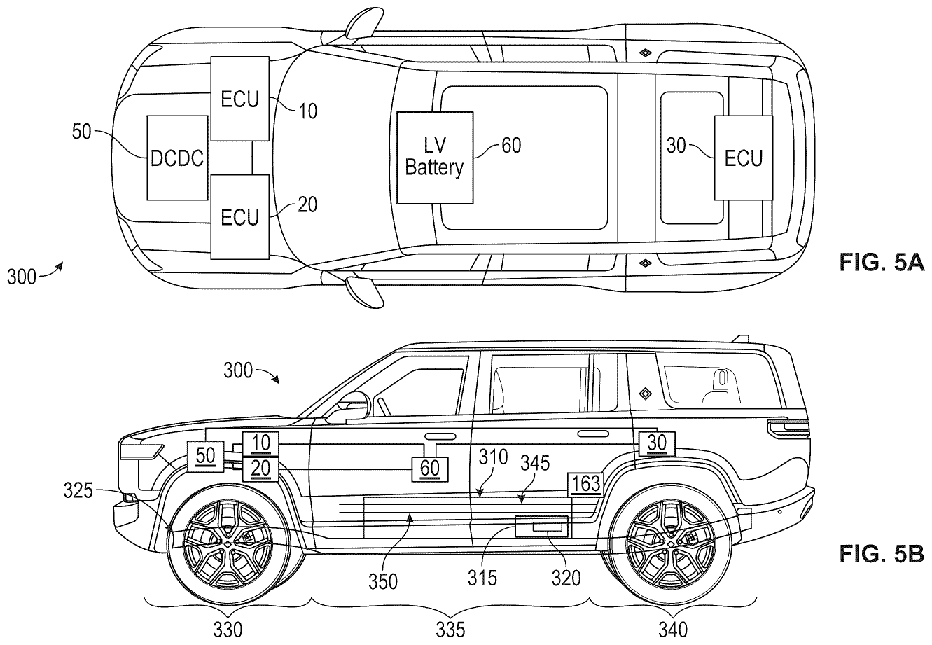

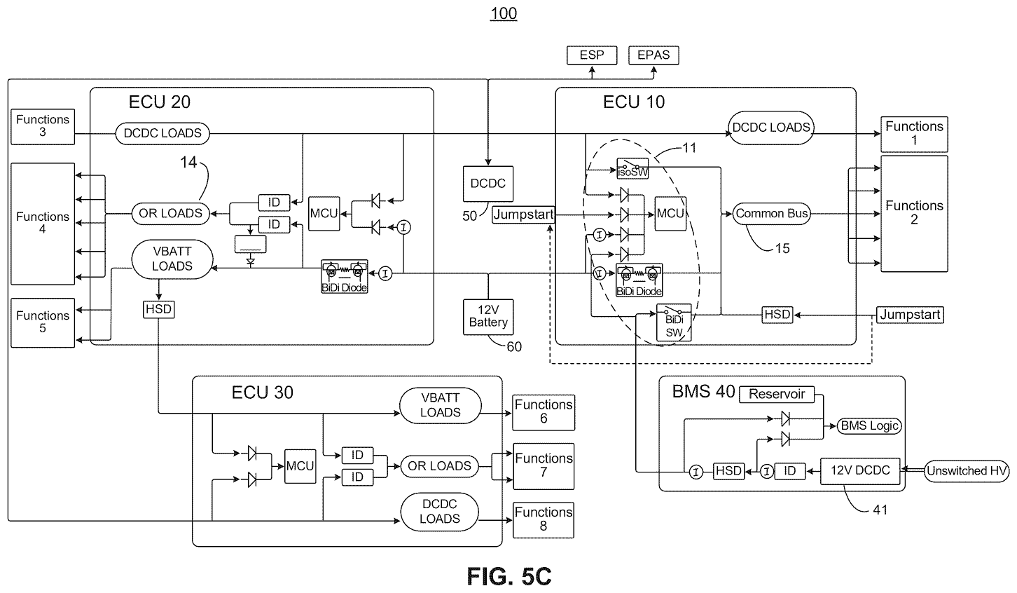

FIG. 1 illustrates an example block diagram of a system 210 of electronic control units (ECUs) that may be associated with an electric vehicle. An ECU is an embedded system that may control one or more of the electrical systems or subsystems in a vehicle. System 210 may include ECU 211, ECU 221, or ECU 231, which may be communicatively connected with each other. ECU 211 and ECU 221 may be located at the front of a vehicle 300 (e.g., vehicle 300 of FIG. 5A). ECU 211 may be located on a first half of the front of vehicle 300 and ECU 221 may be located on a second half of the front of vehicle 300. ECU 231 may be located on a rear of vehicle 300.

The positioning and connections of ECU 211, ECU 221, or ECU 231 may provide for a level of redundancy for faults, which may be caused by collisions or other malfunctions. The design of system 210 may allow vehicle 300 to safely operate for a period after the fault, such as the ability to drive vehicle 300 (e.g., steer, brake, accelerate) to a safe position off of a roadway or the ability to operate electronic controlled components (e.g., door latches) of vehicle 300, among other things. As shown, ECU 211, ECU 221, and ECU 231 may be connected with DCDC bus and a low voltage battery (e.g., 12V battery) to operate DCDC loads and LV battery loads. In an example, one or more ECUs (e.g., ECU 211) may include a fault isolation system 200. In some configurations, in consideration of safety, only one ECU may include fault isolation system 200.

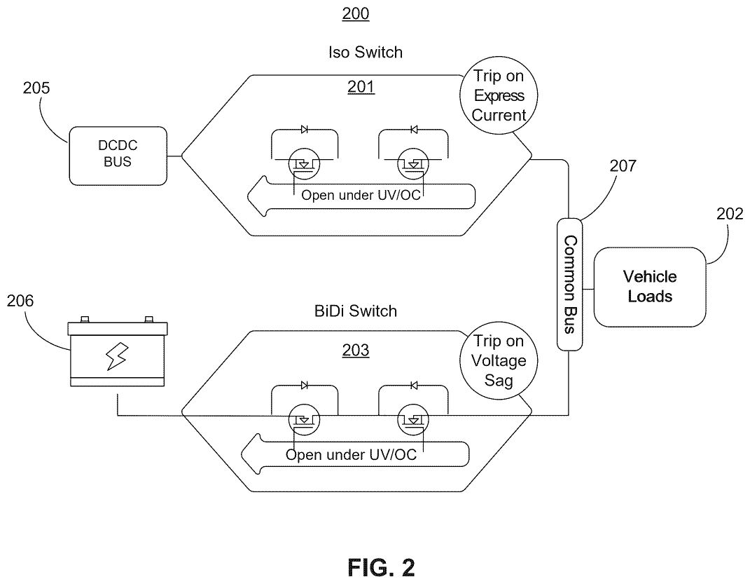

FIG. 2 illustrates an example block diagram of a fault isolation system 200. Fault isolation system 200 may include iso switch 201 or Bidi switch 203 in which both may be connected to vehicle loads 202 via common bus 207. Vehicle loads 202 may be associated with a door latch, frunk latch, front radar, front headlamp, a display, or hazard lamp, among other components. Iso switch 201 may be connected with DCDC bus 205 and Bidi switch 203 may be connected with LV battery 206. Iso switch 201 may trip open and disconnect DCDC bus 205 based on a threshold fault condition, such as undervoltage at input or overcurrent. Bidi switch 203 may trip and disconnect LV battery 206 based on a threshold fault condition, such as undervoltage at input or overcurrent.

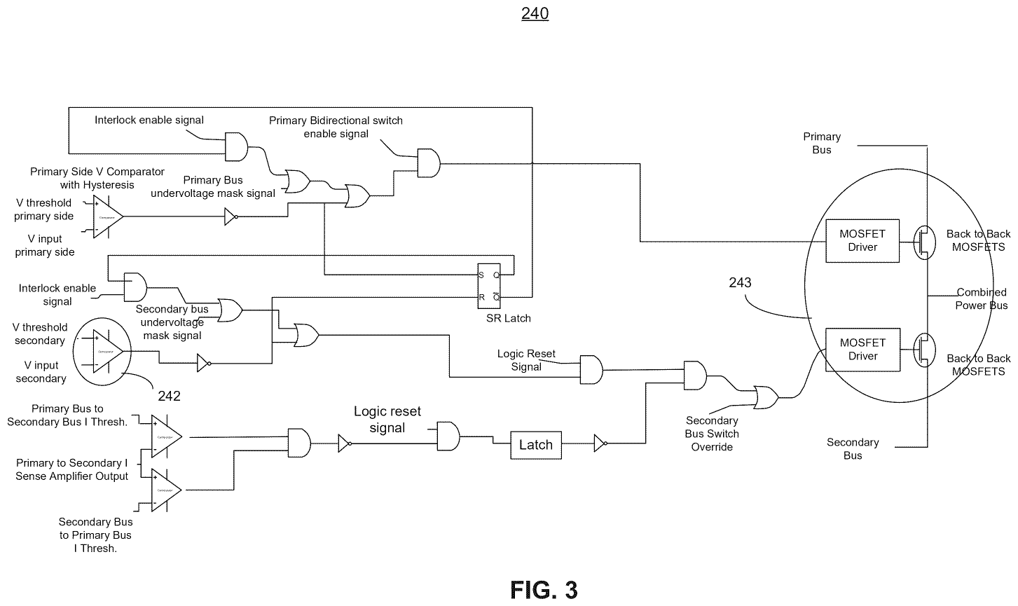

FIG. 3 illustrates an example logic circuit diagram 240 of portions of system 200. Comparator 242 is associated with sensing voltage on the secondary side, wherein the secondary side may be the vehicle's direct current to direct current converter and the primary side may be the low voltage battery. Comparators 242 is associated with sensing voltage on primary side. MOSFETs 243 may be triggered opened based on a threshold overcurrent.

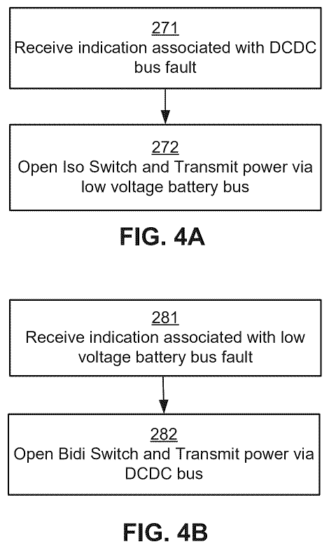

FIG. 4A illustrates an example method for fault isolation as disclosed herein. At step 271, an indication of a fault may be received with regards to a DCDC bus 205 associated with ECU 211. At step 272, based on the indication of the fault on the DCDC bus 205, an isolator switch 201 may be opened and transmit power from a LV battery 206 through a common bus 207 to one or more vehicle loads 202 for operation. Vehicle loads 202 may be associated with a door latch, frunk latch, front radar, front headlamp, a display, or hazard lamp, among other associated with a vehicle.

FIG. 4B illustrates an example method for fault isolation as disclosed herein. At step 281, an indication of a fault may be received with regards to a LV battery bus 206 associated with ECU 211. At step 282, based on the indication of the fault on the LV battery bus 206, a Bidi switch 203 may be opened and transmit power from a DCDC bus 205 through a common bus 207 to one or more vehicle loads 202 for operation.

FIG. 5A illustrates an example overhead view of vehicle 300. As further described herein, vehicle 300 may include electronic control units (ECUs) in front portion 330 of vehicle 300 (e.g., ECU 10 and ECU 20), an ECU in rear portion 340 of vehicle 300 (e.g., ECU 30), a direct current to direct current (DCDC) converter (e.g., DCDC 50), or low voltage (LV) battery 60 (e.g., 12V battery), among other things.

FIG. 5B illustrates an example side view of vehicle 300. As shown, the vehicle 300 may include one or more battery packs, such as high voltage (HV) battery pack 310 (e.g., 450V), which may be located near the center body portion 335 of vehicle 300. HV battery pack 310 may be coupled with one or more electrical systems of the vehicle 300 to provide power to the electrical systems. As further described herein, ECU 10 (e.g., ECU 211), ECU 20 (e.g., ECU 221), or ECU 30 (e.g., ECU 231) may be communicatively connected with or have power distributed with each other and may be functionally redundant for power or other operations of electronic components of vehicle 300.

In one or more implementations, the vehicle 300 may be an electric vehicle having one or more electric motors that drive the wheels of the vehicle 300 using electric power from HV battery pack 310. In one or more implementations, the vehicle 300 may also, or alternatively, include one or more chemically-powered engines, such as a gas-powered engine or a fuel cell powered motor. For example, electric vehicles can be fully electric or partially electric (e.g., hybrid or plug-in hybrid). In various implementations, the vehicle 300 may be a fully autonomous vehicle that can navigate roadways without a human operator or driver, a partially autonomous vehicle that can navigate some roadways without a human operator or driver or that can navigate roadways with the supervision of a human operator, may be an unmanned vehicle that can navigate roadways or other pathways without any human occupants, or may be a human operated (non-autonomous) vehicle configured for a human operator.

In the example of FIG. 5B, the vehicle 300 may be implemented as a truck (e.g., a pickup truck) having a battery pack 310. As shown, HV battery pack 310 may include on or more battery modules 315, which may include one or more battery cells 320. However, this is merely illustrative and, in other implementations, HV battery pack 310 may be provided without any battery modules 315 (e.g., in a cell-to-pack configuration).

As shown in FIG. 5B, the vehicle 300 may include a support structure such as a chassis 325 (e.g., a frame, internal frame, or other support structure). The chassis 325 may support various components of the vehicle 300. As shown, the chassis 325 may span a front portion 330 (e.g., a hood or bonnet portion), center body portion 335, and a rear portion 340 (e.g., a trunk, payload, or boot portion) of the vehicle 300 in some implementations. In one or more implementations, HV battery pack 310 may be installed on the chassis 325 (e.g., within one or more of the front portion 330, center body portion 335, or the rear portion 340). As shown, HV battery pack 310 may include or be electrically coupled with one or more one busbars (e.g., one or more current collector elements). In the example of FIG. 5B, the vehicle 300 includes a first busbar 345 and a second busbar 350, either or both of which may include electrically conductive material to connect or otherwise electrically couple the battery module(s) 315 or the battery cell(s) s 320 with other electrical components of the vehicle 300 to provide electrical power to various systems or components of the vehicle 300.

In other implementations, the vehicle 300 may implemented as another type of electric truck, an electric delivery van, an electric automobile, an electric car, an electric motorcycle, an electric scooter, an electric passenger vehicle, an electric passenger or commercial truck, a hybrid vehicle, or other vehicles such as sea or air transport vehicles, planes, helicopters, submarines, boats, or drones, and/or any other movable apparatus having a battery pack 310 (e.g., that powers the propulsion or drive components of the moveable apparatus).

FIG. 5C illustrates an example block diagram of system 100 that may include a plurality of ECUs of vehicle 300. An ECU is an embedded system that may control one or more of the electrical systems or subsystems in a vehicle. The positioning and connections of ECU 10, ECU 20, or ECU 30 may provide for a level of redundancy for faults, which may be caused by collisions or other malfunctions. The design of system 100 may allow vehicle 300 to safely operate for a period after the fault, such as being able to drive vehicle 300 (e.g., steer, brake, or accelerate) to a safe position off of a roadway or being able to operate electronic controlled functions (e.g., door latches) of vehicle 300, among other things. As shown, ECU 10, ECU 20, and ECU 30 may be connected with DCDC 50 (also referred herein as DCDC bus 50) to operate DCDC loads and a low voltage (LV) battery 60 (e.g., 12V battery or LV battery bus 60) to operate LV battery loads. In an example, one or more ECUs (e.g., ECU 10) may include a fault isolation system 11 (e.g., may include Bidi switch 203 and Iso switch 201 of system 200). In some configurations, in consideration of safety, only one ECU (e.g., ECU 10) may include fault isolation system 11. As shown, ECU 10 may include a common bus 15, (e.g., common bus 207) which may operate slightly differently than other buses (e.g., OR load bus 14), as the common bus 15 may allow for bidirectional power to be transmitted to and from LV battery 60 (e.g., LV battery 206) that may be a function of using fault isolation system 11. The common bus 15 (specific to ECU 10) allows power to flow bidirectionally, from LV battery 60 to DCDC 50, or from DCDC 50 to LV battery 60. The OR bus does not allow power to flow bidirectionally (it does not connect or isolate LV battery 60 and DCDC 50 networks). The other element, which is a shared attribute of both common bus 15 and OR Bus, that in the event of a failure of the DCDC 50 or LV battery 60, the common bus (or “OR bus”) will retain operation (e.g., will be available).

With continued reference to FIG. 5C, each ECU may have on or more dedicated functions that may be powered by DCDC 50 (e.g., DCDC bus 205), LV battery 60, or mini DCDC 41. ECU 10 may operate functions 1, functions 2, and jumpstart functions. Functions 1 may include functions such as first row universal serial bus, or electronic stability program (ESP), among other things. Functions 2 (e.g., vehicle loads 202) may include functions such as right door latch, passenger seat motor, right headlamp, alarm module, or frunk latch, among other things. In this example, functions 1 of ECU 10 may only be powered by DCDC 50, while functions 2 of ECU 10 may be powered by DCDC 50 (which may be the primary power) or LV battery 60 (which may be the secondary power), which may be referred to common bus 15. ECU 10 may be located on the right front of vehicle 300 and therefore may operate functions primarily for the right portion of vehicle 300.

As shown in FIG. 5C, ECU 20 may operate functions 3, functions 4, and functions 5. Functions 3 may include functions such as front suspension valves, or autonomy control module, among other things. Functions 4 may include functions such as steering angle sensor, front wiper motor, left door latches, left headlamp, exterior near field communication (NFC), or on-board diagnostics (OBD) port, among other things. Functions 5 may include functions such as electric power assisted steering (EPAS), charge port door, interior NFC, or electric powered assisted breaking, among other things. In this example, functions 3 of ECU 20 may only be powered by DCDC 50 and functions 5 of ECU 20 may only be powered by LV battery 60. Functions 4 of ECU 20 may be powered by DCDC 50 (which may be the primary power) or LV battery 60 (which may be the secondary power), which may be referred to OR loads 14 (also referred herein as OR load bus 14). ECU 20 may be located on the left front of vehicle 300 and therefore may operate functions primarily for the left portion of vehicle 300.

As shown in FIG. 5C, ECU 30 may operate functions 6, functions 7, and functions 8. Functions 6 may include functions such as license plate lamp. Functions 7 may include functions such as rear vehicle access system sensors, liftgate latch, trailer brake, right lamp rear, or left lamp rear, among other things. Functions 8 may include functions such as right trailer brake lamp, or rear suspension valves, among other things. In this example, functions 8 of ECU 30 may only be powered by DCDC 50 and functions 6 of ECU 30 may only be powered by LV battery 60. Functions 7 of ECU 20 may be powered by DCDC 50 (which may be the primary power) or LV battery 60 (which may be the secondary power). ECU 20 may be located on the left front of vehicle 300 and therefore may operate functions primarily for the left portion of vehicle 300.

System 100 of FIG. 5C may include a battery management system (BMS) 40. BMS 40 may be located at or near HV battery pack 310 of FIG. 5B, which mini DCDC 41 converts the HV DC to a lower voltage, such as 14V. Mini DCDC 41 may help reduce the need for LV battery 60 for some operations, such as when vehicle 300 is in standby mode (e.g., parked). It is contemplated that the functions disclosed herein (e.g., functions 1 through functions 8) may be controlled by other ECUs or powered by any of the listed power sources.

The methods, systems, or apparatuses disclosed herein may be incorporated into electric vehicles or other devices. The methods, systems, or apparatuses disclosed herein may be incorporated into products, such as various feature specific electronic control units (ECUs).

An apparatus, method, or system for fault isolation in power distribution networks is disclosed herein. An apparatus may include a low voltage battery bus; a DCDC bus; and an electronic control unit (ECU), wherein the ECU may include an isolator switch connected with the DCDC bus, and a bidirectional switch connected with the low voltage battery bus. The apparatus may be an electric vehicle. A method may include receiving an indication of a fault on a DCDC bus associated with an electronic control unit; and based on the indication of the fault on the DCDC bus, opening an isolator switch, and transmitting power from a low voltage battery bus to a common bus. Another method may include receiving an indication of a fault on a low voltage battery bus associated with an electronic control unit; and based on the indication of the fault on the low voltage battery bus, opening a bidirectional switch, and transmitting power from a DCDC bus to a common bus. All combinations (including the removal or addition of steps) in this paragraph are contemplated in a manner that is consistent with the other portions of the detailed description.

Methods, systems, or apparatus for fault isolation in power distribution networks are disclosed herein. An electronic control unit may include a direct current to direct current (DCDC) bus; a low voltage battery bus; an isolator switch connected with the DCDC bus; a bidirectional switch connected with the low voltage battery bus; and a common bus connected to the isolator switch and the bidirectional switch. The isolator switch opens when a fault occurs on the DCDC bus, wherein the fault is associated with an undervoltage condition or an overcurrent condition on the DCDC bus. The bidirectional switch opens when a fault occurs on the low voltage battery bus, wherein the fault is associated with an undervoltage condition or an overcurrent condition on the low voltage battery bus. The common bus transmits power to one or more vehicle loads based on one or more vehicle components, wherein the one or more vehicle components include a door latch, a frunk latch, a front radar, a front headlamp, a display, a hazard lamp, or an electric motor. The electronic control unit may include voltage comparators for monitoring voltage levels on the DCDC bus and the low voltage battery bus. All combinations (including the removal or addition of steps) in this paragraph and the above paragraphs are contemplated in a manner that is consistent with the other portions of the detailed description.

A method may include receiving an indication of a fault on a DCDC bus associated with an electronic control unit; based on the indication of the fault on the DCDC bus, opening an isolator switch connected between the DCDC bus and a common bus in response to the fault; and transmitting power from a low voltage battery bus through the common bus to one or more loads. The fault may include an undervoltage condition or an overcurrent condition on the DCDC bus. The one or more loads may be associated with a door latch, a frunk latch, a front radar, a front headlamp, a display, or a hazard lamp. The method may include monitoring voltage and current conditions on the DCDC bus and the low voltage battery bus, wherein the electronic control unit is located in an electric vehicle. All combinations (including the removal or addition of steps) in this paragraph and the above paragraphs are contemplated in a manner that is consistent with the other portions of the detailed description.

Another method may include receiving an indication of a fault on a low voltage battery bus associated with an electronic control unit; based on the indication of the fault on the low voltage battery bus, opening a bidirectional switch connected between the low voltage battery bus and a common bus in response to the fault; and transmitting power from a DCDC bus through the common bus to one or more loads. The fault may include an undervoltage condition or an overcurrent condition on the low voltage battery bus. The one or more loads are associated with an electric motor. The method may include monitoring voltage and current conditions on the DCDC bus and the low voltage battery bus, wherein the electronic control unit is located in an electric vehicle. All combinations (including the removal or addition of steps) in this paragraph and the above paragraphs are contemplated in a manner that is consistent with the other portions of the detailed description.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. An apparatus comprising:
a direct current to direct current (DCDC) bus;
a low voltage battery bus;
an isolator switch connected with the DCDC bus;
a bidirectional switch connected with the low voltage battery bus; and
a common bus connected to the isolator switch and the bidirectional switch.

2. The apparatus of claim 1, wherein the isolator switch opens when a fault occurs on the DCDC bus.

3. The apparatus of claim 2, wherein the fault is associated with an undervoltage condition or an overcurrent condition on the DCDC bus.

4. The apparatus of claim 1, wherein the bidirectional switch opens when a fault occurs on the low voltage battery bus.

5. The apparatus of claim 4, wherein the fault is associated with an undervoltage condition or an overcurrent condition on the low voltage battery bus.

6. The apparatus of claim 1, further comprising one or more vehicle loads, wherein the one or more vehicle loads receive power from the common bus.

7. The apparatus of claim 6, wherein the one or more vehicle loads are based on one or more vehicle components.

8. The apparatus of claim 7, wherein the one or more vehicle components comprise a door latch, a frunk latch, a front radar, a front headlamp, a display, or a hazard lamp.

9. The apparatus of claim 7, wherein the one or more vehicle components comprise an electric motor.

10. The apparatus of claim 1, wherein the apparatus comprises an electronic control unit.

11. A method comprising:
receiving an indication of a fault on a direct current to direct current (DCDC) bus associated with an electronic control unit;
based on the indication of the fault on the DCDC bus, opening an isolator switch connected between the DCDC bus and a common bus in response to the fault; and
transmitting power from a low voltage battery bus through the common bus to one or more loads.

12. The method of claim 11, wherein the fault comprises an undervoltage condition or an overcurrent condition on the DCDC bus.

13. The method of claim 11, wherein the one or more loads are associated with a door latch, a frunk latch, a front radar, a front headlamp, a display, or a hazard lamp.

14. The method of claim 11, further comprising monitoring voltage and current conditions on the DCDC bus and the low voltage battery bus.

15. The method of claim 11, wherein the electronic control unit is located in an electric vehicle.

16. A method comprising:
receiving an indication of a fault on a low voltage battery bus associated with an electronic control unit;
based on the indication of the fault on the low voltage battery bus, opening a bidirectional switch connected between the low voltage battery bus and a common bus in response to the fault; and
transmitting power from a direct current to direct current (DCDC) bus through the common bus to one or more loads.

17. The method of claim 16, wherein the fault comprises an undervoltage condition or an overcurrent condition on the low voltage battery bus.

18. The method of claim 16, wherein the one or more loads are associated with an electric motor.

19. The method of claim 16, further comprising monitoring voltage and current conditions on the DCDC bus and the low voltage battery bus.

20. The method of claim 16, wherein the electronic control unit is located in an electric vehicle.
